(19) United States
(12) Patent Application Publication
(10) Pub. No.: US 2017/0061538 A1
(43) Pub. Date: Mar. 2, 2017

(54) WEB-BASED TRADE COMPLIANCE ASSESSMENT TOOL

(71) Applicant: Craig Thomas Ridgley, Redington Shores, FL (US)

(72) Inventor: Craig Thomas Ridgley, Redington Shores, FL (US)

(73) Assignee: Trade Compliance Group, LLC, Washington, DC (US)

(21) Appl. No.: 15/247,522

(22) Filed: Aug. 25, 2016

Related U.S. Application Data
(60) Provisional application No. 62/210,689, filed on Aug. 27, 2015.

(51) Int. Cl. G06Q 40/04

(52) U.S. Cl. CPC G06Q 40/04; G06Q 50/26

(57) ABSTRACT

A method and system for determining of compliance with trade regulations, or any other federal regulations, includes a web based system for access by a user. The user provides information and answers relating to risk factors or exposure factors of the trading entity. The exposure factors are each assigned a weighting factor. Weighted exposure factor answers are totaled and used to calculate an exposure value. Risk factor answers are assigned values and are compared to possible maximum values. Risk factor answers may be identified as imposing a greater or lesser risk as indicated by color codes. A total of the risk answer values is compared to a total of maximum values to obtain a risk value. The risk value and exposure value are plotted on a matrix. The matrix may be color coded for different levels of risk/exposure. The user may determine from the method and system if consultation relating to trade compliance is warranted.

### CROSS REFERENCE TO RELATED APPLICATION

The present application claims the benefit of U.S. Provisional Patent Application Ser. No. 62/210,689, filed on Aug. 27, 2015, which application is incorporated herein by reference.

### BACKGROUND OF THE INVENTION

Field of the Invention

The present invention relates generally to a system and method for determining compliance with applicable laws and rules of a trade (or other) compliance program for an entity, and more particularly to a web-based, and native web-based, system and method for measuring risk of possible violations of export laws and rules for an entity's trade compliance program.

Description of the Related Art

Entities, such as companies, must comply with laws and rules when conducting trading across international borders. Many entities that do such international trading as part of their business have in place measures to comply with the trading laws. These measures and programs for compliance with the trading laws can be evaluated to determine the likelihood of a possible violation of the trading laws before any such violations occur.

### SUMMARY OF THE INVENTION

The present system and method for trade compliance assessment, also referred to as TCAT method, includes a web-based tool for performing a simple yet indicative assessment of a user's trade compliance program. In certain embodiments, the system and method determine compliance with applicable laws and rules of a trade (or other) compliance program for an entity, using a web-based, and native web-based, system and method for measuring risk of possible violations of export laws and rules for an entity's trade compliance program. For the purposes of this specification, “native web-based” refers to a set of object code that can be delivered to or downloaded by a customer for installation within the company's intranet and/or behind said company's firewall.

### BRIEF DESCRIPTION OF THE DRAWINGS

FIG. 1 is a graphic illustration of a matrix showing risk compared to exposure for trade compliance;

FIG. 2 is a table showing values used in a risk calculation;

FIG. 3 is a table showing an example of an exposure calculation;

FIG. 4 is a graphic illustration of a matrix showing risk compared to exposure for a multiple country compliance program;

FIG. 5 is a process flow chart showing the steps in the assessment process for a trading entity;

FIG. 6 is a schematic illustration showing the network configuration and devices that can access the TCAT in both the cloud-based version and optional corporate firewall version;

FIG. 7 is a screen shot showing the Risk/Exposure Matrix as implemented as a gradient from low risk/exposure in the lower left corner to high risk/exposure in the upper right corner;

FIG. 8 is a screen shot showing color coding of the compliance process sections when the assessment is complete;

FIG. 9 is a screen shot showing the results of the assessment organized in order of criticality and showing a list of the results history;

FIG. 10 is a screen shot of the risk/exposure matrix showing the previous assessment history;

FIG. 11 is a screen shot of the risk/exposure matrix showing multi-country assessment results with the results of the countries represented by an image of the relevant country flag; and

FIG. 12 is a process flow chart showing the steps in the assessment process for a trading entity.

### DETAILED DESCRIPTION OF THE PREFERRED EMBODIMENTS

A typical trade compliance assessment relies on two types of data; hard data such as process and procedure documents, transaction records, etc., and soft data which is information obtained from interviews with trade compliance stakeholders. The present trade compliance assessment, or TCAT method and system, of certain embodiments only rely on soft data provided in the form of answers to questions provided by the trade compliance stakeholder(s).

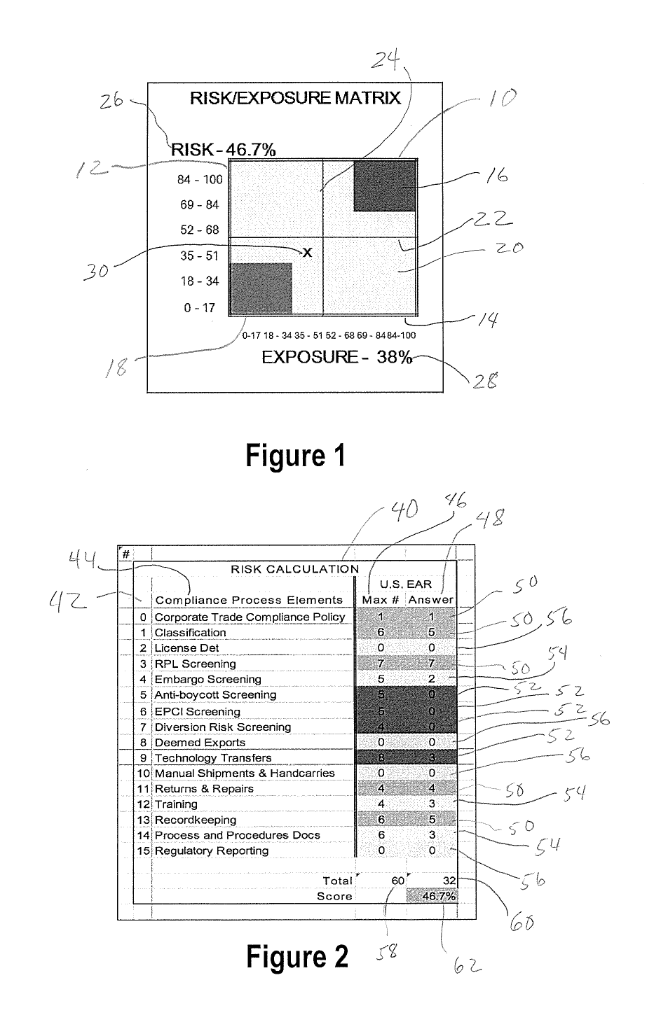

Though the web based method may lack the insights gained by a person reviewing trade compliance process and procedure documents, the TCAT method provides a meaningful perspective on the user's trade compliance program by measuring both the risk of possible violations and the level of exposure to bad consequences. This latter metric may be significant in that the exposure to bad consequences (violations of federal laws) is quantified in a trade compliance assessment methodology. Traditional assessment methodologies are one-dimensional and only qualify the level of risk as a subjective assessment of individual compliance processes. The TCAT method quantitatively establishes the level of risk and exposure in two dimensions. When the risk/exposure values are plotted as XY coordinates on a quadrant, the user can visually see where their compliance program sits, as shown in the example below in FIG. 1.

In FIG. 1 is shown a risk/exposure matrix 10 as a graph with a risk value plotted on the vertical axis 12 and an exposure value plotted on the horizontal axis 14. The risk/exposure matrix 10 may be shown on a display of a computer device or other device, may be printed, or otherwise displayed to a user. The matrix 10 indicates a first region 16 in a first color at the upper right of the matrix 10. A second region 18 is indicated in a second color at the lower left of the matrix 10. The remaining portions form a third region 20 of the matrix 10 are shown in a third color. In one example, the first color of the first region 16 is red, the second color of the second region 18 is green, and the color of the third region 20 is yellow. In the example, the risk values on the vertical axis 12 have a range of 0% to 100%. The exposure values on the horizontal axis 14 have a range of 0% to 100%. A horizontal line 22 and a vertical line 24 bisect the respective sides and divide the matrix 10 into generally equal quadrants. The first region 16 occupies an area less than the upper right quadrant and the second region 18 occupies an area less than the lower left quadrant. In certain embodiments, the first region extends from 69% to 100% of the risk value and from 69 to 100% of the exposure value. The second region of certain embodiments extends from 0% to 34% of the risk value and from 0% to 34% of the exposure value. In certain embodiments, the first region 16 is of a red color, the second region 18 is of a green color, and the remaining area 20 is of a yellow color.

Values for an assessment have been plotted on the matrix 10. In the illustrated example, a risk value of 46.7% has been assigned as indicated at 26 and an exposure value of 38% has been assigned as indicated at 28. The intersection of the assessed values is indicated by an X or other mark 30. The mark 30 for this assessment shows that the risk/exposure plot is in the lower left quadrant but not in the second area 18. The goal of an entity may be to have the risk/exposure plot within the second area 18 or at least to avoid having the risk/exposure plot within the first area 16. The entity may take measures to move the risk/exposure plot to closer to or within the second area 18. Any changes that result in the risk/exposure plot being moved closer to or within the first area 16 may be avoided or reversed.

### Risk Value

The risk value 26 is a measure of the level of preparedness of the user in terms of documented processes and procedures. The better documented the trade compliance program, the less risk that a violation is going to occur. Typically in an on-site assessment conducted by a consultant, the trade compliance processes and procedures would be reviewed by the consultant and compared to the answers given regarding those processes obtained through the interviews. A high correlation between what is documented and what an interviewee states regarding a given process indicates a solid process. A low correlation, or ignorance of the process, indicates a trade compliance issue requiring attention. The trade assessment TCAT method will not be able to make such a correlation, but must attempt, through skillfully crafted questions, to ascertain the state and status of the applicable trade compliance processes. There are approximately 20 potentially applicable trade compliance processes that must be assessed, depending upon the nature of the user's business.

### Exposure Value

The exposure value 28 is a measure of the environmental factors of the user's business, such as product type (e.g., high tech, low tech, defense article), market geography (i.e., North America. Middle East, Asia, South America, etc.), sales channel (B2B, retail, distribution, internet, etc.), export volume in dollars, and off-shore activities (R&D or manufacturing). All of these factors are weighted using values that represent a reasonable inference of exposure. For example, a company in the medical device industry has a much lower exposure to bad consequences than a company who deals in defense articles. However, medical device companies often trade with embargoed or sanctioned countries as their products are generally excluded from control under the Export Administration Regulations. As a result, the type of product would warrant a lesser exposure rating, but the market geography would warrant a higher rating because of the probability that transaction could result in an extremely serious violation. Typically, the exposure value, once determined, does not vary as a result of trade compliance process improvement. The environmental factors do not change unless the company changes their business model.

### Assessment Questions

The assessment questions may gather as much relevant data as possible. It may capture all of the environmental information necessary for the exposure value, and the state and status of each of the applicable trade compliance processes for the risk value.

Company Information

Company Name

Company Address

Business Unit

Assessment Site (if different from Company Information)
Site Name
Site Address
Business Unit

Trade Compliance Contact Information
Name
Title
Office Phone Number
Mobile Phone Number
Email Address

### Exposure Questions

The exposure questions include questions relating to:

Product Types

Sales Regions

Sales Types

Volume of Export as a Percent of Sales

Off-shore Activities

Number of Foreign Subsidiaries

Number of Employees

Percent of Foreign National Employees

Number of Vendors

Number of Customer

Number of M&A's

Enforcement Activities

Product Types

Defense/Aerospace

High Tech (Enterprise)

High Tech (Consumer)

Encryption/Cybersecurity

Low Tech

Oil & Gas

Medical/Pharma

Nuclear/Chemicals/Biologicals

Technology

Sales Regions

European Union

Middle East

Africa

Asia/S.E. Asia

Central & Latin America

North America

Embargoes Countries

Sales Types

Direct Sales (Enterprise)

Direct Sales (Consumer)

Distributors

Value-add Resellers

Internet Sales

Export Volumes as a Percent of Sales

High

Medium

Low

Off-Shore Activities

Manufacturing

Engineering/R&D

Number of Off-Shore Subsidiaries

1-10

11-20

21-30

31-40

40+

Number of Employees

Less than 100

101 to 1000

1001 to 5000

5001-10,000

Greater than 10,000

Percent of Foreign National Employees

None

Less than 10%

10% to 20%

20% to 30%

30% to 40%

40% to 50%

Greater than 50%

Number of Vendors

Less than 100

101 to 500

501 to 1.000

1,001 to 5,000

Greater than 5,000

Number of Customers

Less than 1000

1001 to 5000

5001 to 10,000

10.001 to 50.000

Greater than 50.000

Number of M&A's

None

1 per year or less

2 to 5 per year

5+ per year

Enforcement Activities

No enforcement actions in past 5 years

Voluntary Self-Disclosure in past 2 years

Voluntary Self-Disclosure in past year

Current active Voluntary Self-Disclosure

Current active investigation by Federal agency

Would rather not answer

Some of the environmental factors will be “Check All That Apply”; these will have “check boxes.” Questions where the answers for which are mutually exclusive will have radial buttons. As mentioned above, each of the factors is weighted. The total of all of the weightings represents the maximum level of exposure.

### Trade Compliance Process Questions

The trade compliance process questions address the following processes:

Corporate Export Compliance Organization & Policy

Classification

License Determination, Exceptions, & Applications

RPL Screening

Embargo Screening

Anti-boycott Screening

EPCI Screening

Diversion Risk Screening

Deemed Exports—Hiring of Foreign Nationals

Deemed Exports—Unscheduled Visits by Foreign Nationals

Deemed Exports—Scheduled Visits by Foreign Nationals

Technology Transfers

Hand Carry Exports

Manual Exports

Returns & Repairs

Training

Record Keeping

Process and Procedures Does

Internal Audits & Assessments

Regulatory Reporting

The questions determine the state of a process; i.e., does a process exist, and the status of the process; i.e., has the process been recently reviewed and updated accordingly. The questions also attempt to assess the effectiveness of the process by collecting any evidence that the process is not working correctly.

The possible answers for the questions relating to each process are “yes/no/don't know/or NA (not applicable).” The value of each process is determined by the number of “yes” answers out of the total applicable questions. Some questions may be not applicable (NA). For example, if there are five questions on classification and the answers are two yes answers, two no answers, and one NA answer, the score for that process would be two and the total number of applicable questions would be four. Each section can be completed independently, and the user interface for this on the website allows for such a preference.

The process questions are directly related to the current and existing export control regulations under the EAR (Export Administration Regulation) and/or ITAR (International Traffic in Arms Regulation). These regulations change continuously, especially in light of the Export Control Reform. As a result, the question set posed to the user may change as a result of changes to the regulations. Therefore, the process questions are subject to change without notification.

### Variable Question Sets

The first question in each process section determines the need for the assessor to answer the remaining questions in that section or not, as the case may be. A “No” answer to the first question will automatically collapse the rest of the questions in that section and score the section as a complete “red”. In contrast, if the first question is answered “N/A” because presumably that section does not apply to the company's compliance program, that section will automatically collapse the rest of the questions in that section and it will be scored as a “grey” and not be used in the overall calculation.

Additionally, some questions within a given section will be related to subsequent questions, such as:

“Is there a documented process for performing RPL screening?”
If the answer to that question is “Yes”, the following questions relating directly to that process document will remain in the question set. However, a “No” answer to that question will automatically collapse the subsequent questions relating to RPL screening process document and they will not be included in the calculation.

Contrarily, a question may be asked such as:

“Does your company classify products for export internally with company employees?”
If the answer to that question is “Yes”, the subsequent (and unrelated) questions will remain. However, if the answer is “No”, new questions relating to the classification of products will appear in an attempt to ascertain more information about the classification process. This automatically controlled, plus or minus question set function applies to almost all sections within the TCAT.

### Trade Compliance Process Questions for Licensed Users

The Trade Compliance Process questions are based on the inventor's experience and a generally accepted set of relevant of trade compliance processes. However, some larger companies may wish to “tweak” or modify the process questions to account for the type of business they are engaged in, or use terminology better suited to their industry or culture. Companies who wish to have access to the questions will need to license the TCAT software. Thus, licensed users can change nomenclature or subject matter. However, all license-based modifications to the Trade Compliance Process questions must be reviewed by TCG to ensure compatibility with calculation algorithms.

Further, licensed users, typically being larger companies, will prefer to use the native or downloadable version of the TCAT, rather than the web-based version in the “cloud.” The native version is identical to the web-based version except that it can be installed behind a company's firewall on an internal web-server that can be accessed by authorized company users. The native version will require some internal software support and maintenance.

### Assessment Results

Risk Calculation

After all of the applicable processes have been addressed, the total applicable questions would be divided by the total number of “yes” answers and then subtracted from 100 to give the risk value.

In addition to display of the results of the questions in the risk/exposure matrix quadrant 10 of FIG. 1, the applicable processes will be listed and color coded in a risk calculation table 40, as shown in FIG. 2, below. In FIG. 2 is shown a risk calculation shown as a table 40 with a first column 42 assigning sequential numbers to the entries, the second column 44 listing the compliance process elements, the third column 46 showing the maximum value for the corresponding element, and the fourth column 48 showing the value assigned to the answers provided under each compliance process category being displayed.

The columns 46 and 48 are color coded depending on the level of compliance indicated by the answers. For example, answers that are at or near to the maximum answer are highlighted in a first color 50, for example green. Answers that depart significantly from the maximum value are highlighted in a second color 52, for example red. Answers that are between the values indicated by the first color and the second color are highlighted in a third color 54, for example yellow. Answers for which a maximum value is zero is are highlighted in a fourth color 56, for example gray.

In the illustrated example, the answers for the corporate trade compliance policy and RPL screening are at the maximum values of 1 and 7, respectively, and are shown in the first color 50. The classification answers are at 5 out of a maximum of 6, and are also shown in the first color 50. The embargo screening answer is at 4 out of a maximum of 5, and is highlighted in the third color 54. The answers to the anti-boycotting screening questions are 0 and so are shown in the second color 52. The technology transfers answers are 3 out of a possible 8, and are also highlighted in the second color 52. In the example, the deemed exports questions have a maximum value of 0 and are shown in the fourth color.

The maximum value numbers are totaled at 58 and the answer values are totaled at 60. A score is calculated at 62 as a percentage using the formula,

1−(answer total/max. total)=score

In the example, the assessment determined that the entity had an answer score 32 out of a possible 60, giving a scope of 46.7%.

The darker shading or second color 52, which is displayed as the color red in certain embodiments, may indicate that a process is non-existent or severely broken. The lightest shading or third color 54, which may be displayed as yellow in certain embodiments, indicates that the process is in need of attention. An intermediate shading or first color 52, which may be shown as green in certain embodiments, will indicate that the process is acceptable. The scoring of an individual process will be based on the percent of “yes” answers relative to the number of applicable questions. For example, if there are six questions on license determination and all six are applicable, and there are four “yes” answers, that would result in a score of 66%. In certain embodiments, any score above 75% would be colored red. Scores between 75% and 50% would be colored orange. Scores between 50% and 25% are colored yellow. Any score below 25% would be colored green. Any process that is determined to be not applicable will be greyed or highlighted in the fourth color 56 and not considered in the calculation.

### Exposure Calculation

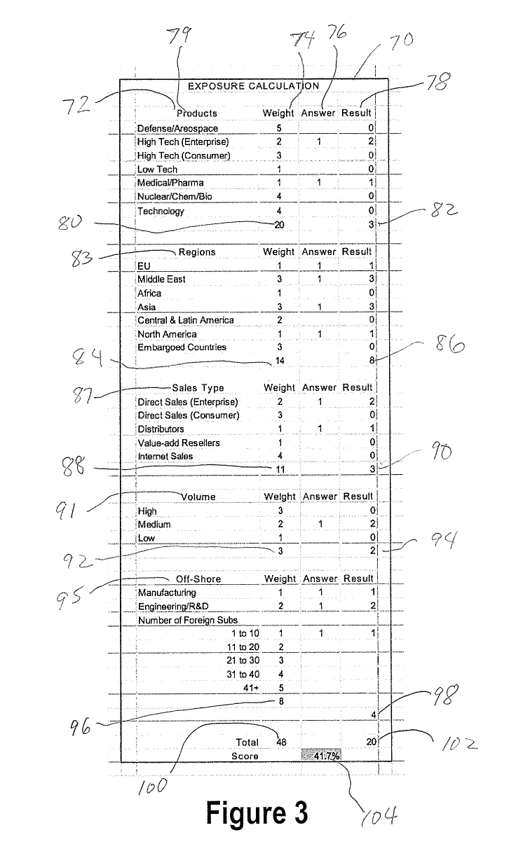

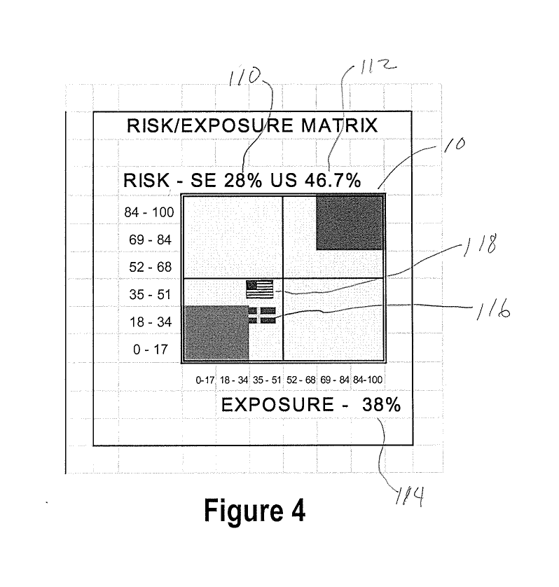

As referred to above, the exposure questions are all weighted based on years of experience in trade compliance and common sense. Other means of determining weighting may be provided as well. FIG. 3 shows the current weighting for each question. In FIG. 3 is shown an exposure calculation table 70 having a first column 72 showing categories and sub-categories, a second column 74 showing weighting values, a third column 76 showing the answer, and a fourth column 78 showing a result. In the illustrated example, the first category 79 is products, which assigns different weights to different classes of products provided by the entity. For example, defense and aerospace products have a weighing of 5, whereas medical and pharma products have a weighting of 1. If a company sells products in one or several of the classes, the answer is multiplied by the weighting factor and provided in the result column 78. The weighting factors for all classes of products are added to obtain a total 80 and the weighted answers or results are totaled at 82.

The second category 83 is regions. Each region into which the sales are made is assigned a weighting factor in column 74. The answers in column 76 are multiplied by the weights to obtain the results in column 78. The region weighting factors are added at 84 and the results are added at 86.

In the category for sales type 87, the types of sales that the entity may conduct are assigned weights in column 74. The answers in column 76 are weighted in column 78. The total of the sales type weights are provided at 88 and the total for the weighted results are provided at 90.

In the category for volume 91, the sales volumes are assigned weights depending on whether the sales are low, medium or high. The maximum value for the weight is provided at 92 and the result total is provided at 94.

A category entitled off-shore 95 addresses whether the entity has facilities out of the country and the number of foreign subsidiaries that the entity has, assigning a weighting to each. The total of the off shore weightings is combined with the maximum value of the weightings for foreign subs at 96 and the total of the weighted answers is provided at 98.

For categories where an answer by the user may be affirmative or negative, the weighting factors are added for the totals. For categories wherein the user may choose one of several different answers, the maximum weighting factor is used as the value to add for the total.

The totals for all of the categories are added at 100 for the weightings and at 102 for the weighted results. From these two totals, a score 104 is calculated. The score in the example is (weighted answer total/weightings total)=score in percent.

The sum of the weighted results is divided by the total maximum possible score to achieve the exposure value to be used on the risk/exposure matrix.

### Display of Assessment Results

After the user accesses the assessment service provided by the TCAT method and takes the assessment by answering the questions, the initial results of the assessment are displayed as the risk/exposure grid with a predetermined statement as to the level of compliance indicated on the risk axis. For example: “Your compliance program has processes that require attention. Please review the risk calculation dialog box to identify the red and yellow processes.”

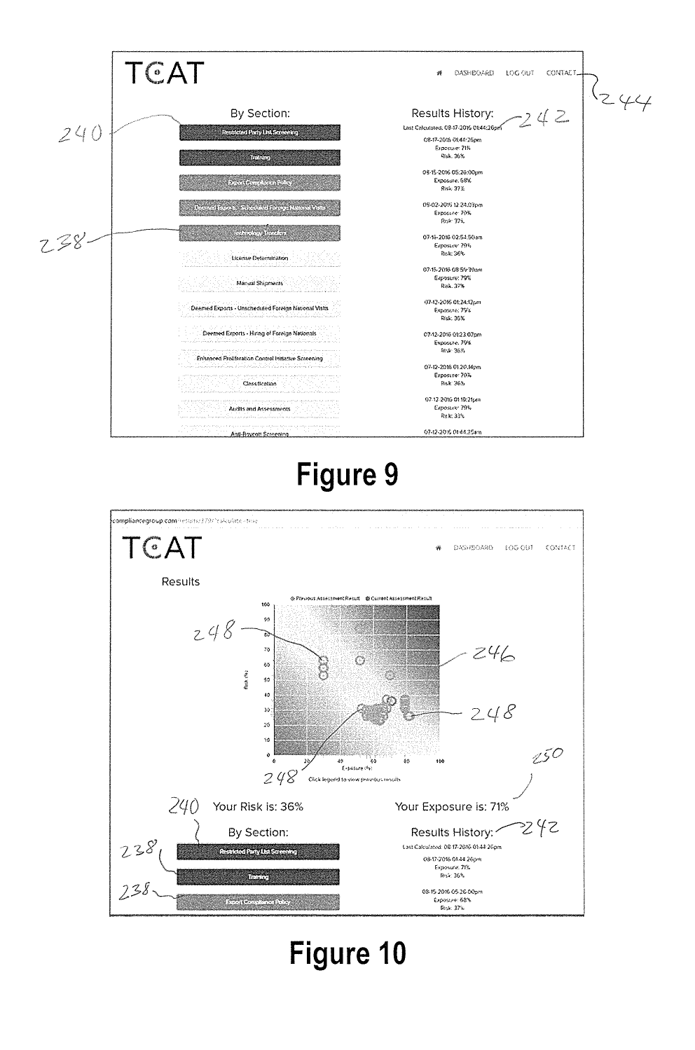

Below the presentation of the Risk/Exposure Matrix, the assessed sections are color coded based on their green/yellow/orange/red status, and displayed in order of criticality; i.e., reds followed by oranges, followed by yellows, and finally greens. (FIG. 9) Any section that was excluded from the calculation (as N/A), is color coded grey. This ‘stoplight’ color coding helps the assessor focus in on areas that are of concern and need improvement as a visual aid based on the calculations for each section.

Note that the Results History of all previous assessments on that site are provided on the right. A “Previous Assessment Results” radial button on the Risk/Exposure Matrix will display all previous X/Y plots of previous assessments, as shown in FIG. 10.

The user has access to:

Additional information with regard to the status of each of the assessed processes; e.g.,

stoplight score and numerical score, and

A one-hour consultation with an TCG consultant to review the findings

Ability to repeat the assessment and compare with previous assessment to view progress

### User Interface

Computer Graphical User Interfaces (GUI)

The following computer GUI's are be supported:

Windows

Mac

Linux

Computer Browser Support

The following computer browsers are supported:

IE 9+

Google Chrome

Firefox, Safari

### Content Management System

The underlying software for the TCAT method is an extension of both WordPress, and a tool called iThemes Exchange. While those components are free/sold and thus fall under open-source license purview, the TCAT software itself is not released publicly, except as output for the end user to make use of.

### Accessing and Use of the Tool

Access Limitations

Access to the TCAT method is limited to paying customers.

Valid Email Address

One mechanism that is required is a valid email address in certain embodiments. In order for a potential user to access the TCAT method, the user will need to enter a valid email address to which the TCAT software will send a key or code that must be entered into the tool to permit access.

### Additional Information Requested

Other information requested will include, but not limited to:

Company Name

Contact Name

Contact Title

Contact Phone Number

Accept Terms and Conditions

Prior to accessing the TCAT method and software, but after entering the key, the potential user will need to accept the terms and conditions of the license agreement. The details of which will need to be address by TCG counsel.

### Disclaimer

In addition to the license agreement, a disclaimer with regard to the “fitness for use”, accuracy, or liability of TCG needs to be displayed as well. Also TBD by legal counsel.

### Payment

If the potential user wishes to obtain the detailed assessment results, payment will be made by:

Credit/Debit Card

Purchase Order

### Additional Functionality

Geolocation-Based Questions

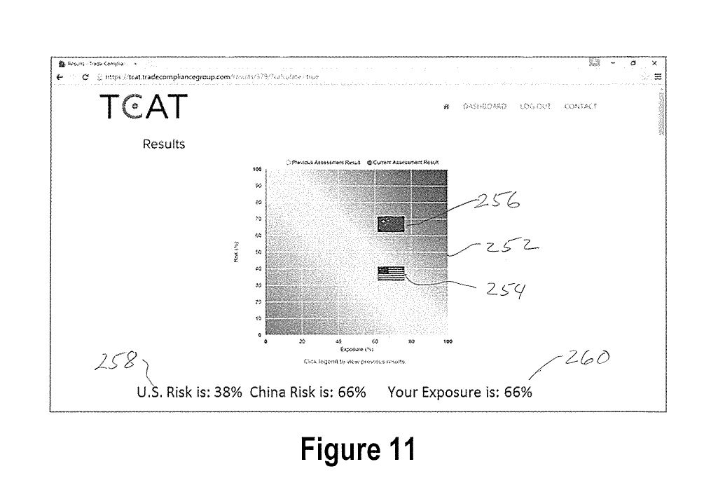

The TCAT method uses the user's computer location services (if available) to determine the country in which the assessment is being performed using an automatic geo-locating function. If the site or facility on which the assessment is being performed is outside the United States, a different set or sets of questions are provided to the assessor. These questions address the export controls of the local country in addition to questions specifically directed at U.S. re-export controls. Though U.S. re-export controls are largely similar, there are subtle and significant distinctions that bear a separate set of questions. These non-U.S. questions will provide the same type of results as the U.S.-only questions, but will measure the risk and exposure for compliance with local laws as well as U.S. re-export controls. For example, sites outside the US are also asked questions related to local “in-country” export regulations, such as questions on the Chinese “e-book” system of balancing imports of materials relative to exports of finished goods, or on the licensing of encryption items out of Israel (which are different from any other country's regulations). Scores for will be represented on the risk/exposure matrix using flags to indicate the score for the U.S. and the local country, as shown in FIG. 11.

With reference to FIG. 11, the risk exposure matrix 10 is the same as the matrix 10 of FIG. 1 except that separate risk/exposure calculations are performed for a business unit under the two applicable jurisdictions of the entity; i.e. local country laws and U.S. re-export laws. The risk value and the exposure value are determined for the business unit under each country's and the values are plotted on the matrix 10. In the example, an entity has used the method to determine a risk value under Chinese laws and for US law. The risk value for the Chinese jurisdiction is shown at 110 with a value of 66% and the risk value for the US re-export jurisdiction is shown at 112 with a value of 38%. The exposure value for the Chinese business unit under both jurisdictions is shown at 114 with a value of 38%. The values are plotted on the matrix 10. The plot for the Chinese jurisdiction is indicated with a Chinese flag 116 and the plot for the US jurisdiction is indicated with a US flag 118. Other indicators may be used for the plots as desired.

In the case where a user (assessor) may be in one country and performing an assessment of a site or facility in another country, the user can override the auto geolocation function and the TCAT method and software will automatically use the address of the assessed site (entered in the exposure questions section) to determine if the assessed site is in the U.S. or outside the U.S., and use the relevant question set or sets. For example, a compliance manager, with multiple sites, may choose to assess all of the sites from the U.S. regardless of location. On the other hand, such a manager of multiple sites might direct all of his sites to take the assessments themselves, in which case the auto geolocation determination would be active.

Though not all countries or regions may be immediately available, it is intended that support may be provided for the following countries/regions:

European Union

Israel

Switzerland

Norway

China

Singapore

Hong Kong

Canada

If the assessor does not wish to complete the assessment for local export controls, the assessor can “opt out” of that part of the assessment and only do the U.S. assessment as it relates to U.S. re-export controls.

### Automatic Modification to Weightings

The weightings of both the exposure questions and risk questions are initially fixed based on the knowledge and experience with trade assessment. It is these weightings that permit the TCAT to accurately quantify the Risk and Exposure in any given assessment. However, it is further understood that the fixed weightings are not universally applicable in all assessments. With that in mind, the TCAT automatically (in real-time) adjusts the weightings of risk questions based on the answers to the exposure questions.

For example, if the answers to exposure question regarding Product Types included High Tech Consumer and Encryption/Cybersecurity, and the answer to Sales Regions included the Middle East and Embargoed Countries, and the Sales Type included Internet Sales, and the Number of Customers were indicated at 10,000 to 50,000, the weighting for RPL Screening Questions (and others) would of necessity warrant substantially different values from those for Product Types of High Tech Enterprise, Sales Regions of the EU and North America, Sales Types of Direct Sales, and Number of Customers less than 1000.

It is far more important to understand the degree of risk of dealing with a Restricted Party in the former scenario than in the latter. Hence, the weightings of the RPL Screening risk questions would be increased.

Conversely, a low tech product sold by direct sales to a small number of customers in South America only might warrant a decrease weighting for RPL Screening risk questions.

An interface is provided for consultants to review the assessments (as opposed to the Release 1 system of having the consultant login to the backend of the tool). Every finished assessment will generate a “consultant report”, viewable to consultants only, in addition to the final results the customer views.

An administrator interface is provided for compliance officers or executive which will allow them to distribute, monitor, and review assessments performed at remote sites. This will provide compliance officers or executives with the ability to manage multiple ongoing assessments, monitor progress, and result in a more comprehensive assessment of their company's compliance.

After completion and submission of the assessment, when the assessor returns to the dashboard, the buttons they use to navigate between sections is colored based on their green/yellow/red status. This will also apply to the sections listed in the results page. This ‘stoplight’ color coding helps the assessor focus in on areas that are of concern and need improvement as a visual aid based on the calculations for each section

A “settings” function is provided to allow assessors to configure certain features, such as the length of time before reminder emails are automatically sent out to remind assessors to complete the assessment.

A ‘reminder’ script is developed that automatically emails assessors who have yet to complete their assessment (similar to when someone has filled their cart on an ecommerce store, but has yet to pay). The function is configurable in the Settings function by the assessor or an administrator (see the administrator interface information above).

A ‘re-take assessment’ script is provided that automatically emails assessors or administrators after a certain amount of time asking them to retake the assessment. This will allow assessors the ability to see the progress being made on improvements to their compliance program.

A “privileged and confidential” button is provided when the administrator is legal counsel and wishes the assessment or assessments to be conducted under privilege. This button may be in the Settings function.

A scheduling application is provided to allow customers to choose the time slot they want for their consultation with the consultant, based on consultant's availability.

The TCAT method and software has the ability for an assessor or administrator to send the TCAT assessment to a colleague and allow them to answer specific sections without having access to the entire tool. Once the colleague completes the specific section of the tool, they will submit their answers which will be entered into the assessment.

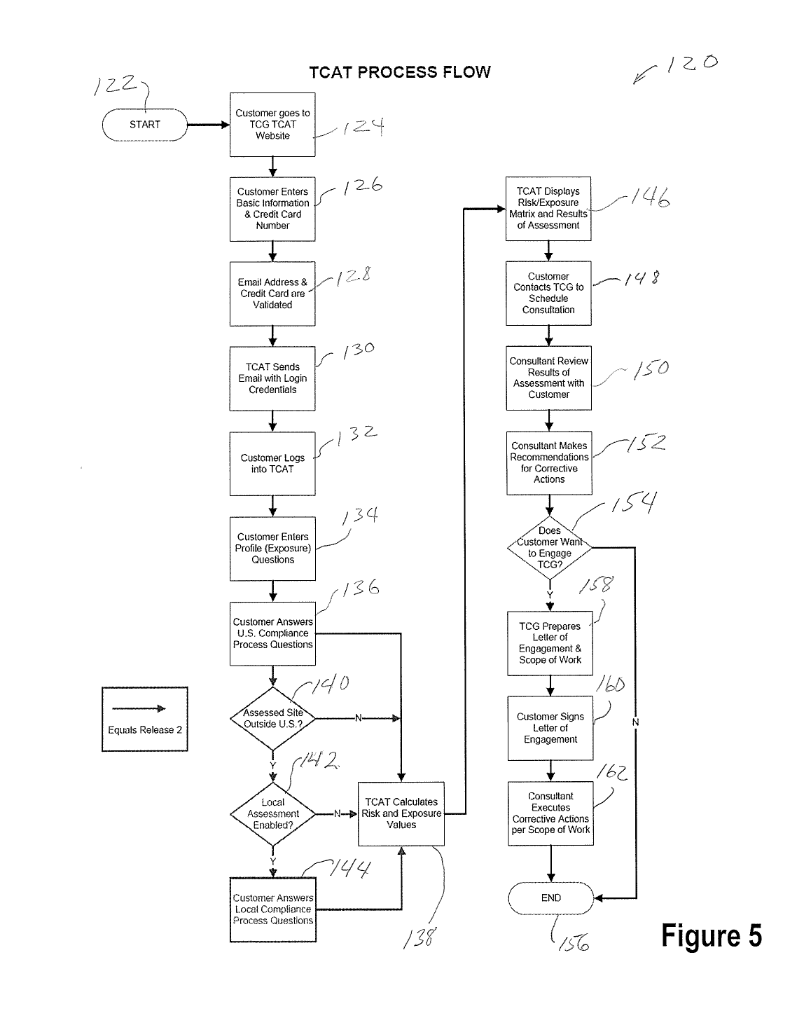

Referring to FIG. 5, a process flow 120 is shown for the assessment method. The process starts at the start 122. The customer or user accesses the website where the web based assessment tool is available, at step 124. The customer enters basic information and a payment method such as credit card information at 126. At step 128, the user's email address and credit card information are validated. Log in credentials are sent to the user via email at step 130. At step 132, the customer logs into the assessment system.

In step 134, the customer or user enters profile information so at to answer the exposure questions. In step 136, the customer or user enters U.S. compliance process questions. In certain embodiments, the process proceeds to step 138 where the software calculates the risk and exposure values according to the method using only the U.S. based information. In alternate embodiments, the process proceeds from step 136 to an inquiry at step 140 as to whether the site being assessed for compliance is outside the United States. If the answer to this inquiry is no, the process proceeds to step 138. If the answer to the inquiry 140 is yes, the process proceeds to step 142 which determines if a local assessment has been enabled. If the local assessment has not been enabled at 142, the process proceeds to step 138. If the local assessment has been enabled at 142, the process proceeds to step 144 at which the customer or user answers questions relating to local compliance processes. At the completion of step 144, the process proceeds to step 138.

At the completion of step 138, the software and method at step 146 displays the risk/exposure matrix marked with the values and plot or plots as determined from the calculations on a display apparatus of a computer, smart phone, tablet, kioske or other display. The results of the assessment are also shown. The matrix and results may instead or additionally be provided as printed information or otherwise conveyed to the user.

In step 148, the user or customer of the method and software contacts the company to schedule a consultation. The consultation may be requested where the matrix 10 shows that the customer's practices indicate a greater risk and/or exposure for trade compliance than is acceptable to the customer. For instance, the matrix 10 may show the plotted value in the yellow zone or even in the red zone. Of course, the user may also request the consultation if the values plotted on the matrix 10 are in the green zone. The user may request a consultation where the user seeks to understand the compliance issues, and particularly where the customer seeks assistance in changing procedures to reduce the risk or exposure.

In step 150, a consultant review of the assessment with the customer or user is performed. In step 152, the consultant may make recommendations for changes or corrective actions in the user's procedures or structures. In step 154, an inquiry is made as to whether the user wishes to engage the trade compliance company. If the answer to the inquiry is no, the process proceeds to the end at 156. If the inquiry answer is yes, the process proceeds to step 158 at which the trade compliance company prepares a letter of engagement and a definition of the scope of the work to be performed. At step 160, the customer signs the letter of engagement. At step 162, a consultant of the trade compliance company executes corrective actions in accordance with the scope of work. At the completion of the consultant's work, the process ends at step 156.

Thus, there is shown and described a process by which a user may access a web based system and answer a number of questions and provide certain information. As a result of the provided information, the user is provided with an assessment of risk and exposure for non-compliance with trade regulations. The assessment of risk and exposure is provided to the user in a direct and easy to understand display via a matrix. The user provides the information to the web based system without requiring that a consultant contact the user to make the assessment. An evaluation of compliance with trade regulations may be made without requiring time and expense of skilled professional compliance personnel.

The web based assessment of trade compliance risk and exposure may serve as an initial investigation by a company to determine if further actions are called for. The web based trade compliance assessment tool may free up skilled professionals of the company's compliance department to focus on those sites who need and seek help, while filtering out those sites that have lower risk or exposure or who do not seek help. Greater efficiency is realized.

The web based process and method and system may include one or more servers on which the web based software is provided. The server or servers may be connected to a network, such as the internet, for access by user equipment. For example, the user equipment may be a desktop computer, laptop computer, netbook computer, tablet computer, workstation computer, smart phone, personal digital assistant, game system, smart TV, kioske, or other device capable of accessing the software on the server for display to the user and for receiving input from the user. The devices may include or use web browser software or other software to display information to the user and to provide the user input to the server.

The server may store the user provided information in a memory or other storage. The user information may be provided to the company for use in defining the scope of the engagement and for use by the consultant in implementing corrective actions. The person of skill in this art will understand the possible variations of hardware and software by which the present method and system may be implemented.

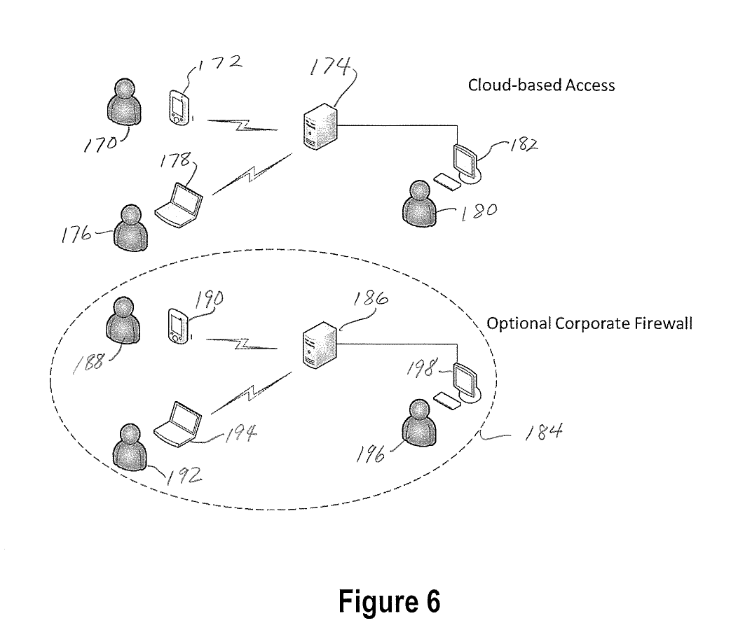

In FIG. 6, a first user 170 uses a smart phone 172 to wirelessly access a server 174 on which the web based trade compliance system is stored. The first user 170 may use the smart phone to follow the process steps shown in FIG. 5, for example. The first user 170 may answer questions relating to trade compliance for a first trading entity. A second user 176 may use a laptop computer 178 to wirelessly access the server 174 and access the web based trade compliance system. The second user 176 may be answering questions and providing information about the first trading entity or may be providing information and answering questions about a second trading entity. The first and second trading entities may be entirely separate from one another or may be related entities, such as related entities in different countries. The users 170 and 176 may provide location information to the trade compliance system running on the server 174 or the smart phone 172 and/or the laptop computer 178 may provide location information to the server 174 based on location devices in the smart phone 172 or laptop computer 178, such as GPS locating devices.

After one or both users 170 and 176 reviews the matrix 10 and/or the risk and exposure calculations according to the method, one or both of the users 170 and 176 request a consultation. A consultant 180 uses a computer 182 to access the server 174 and may retrieve the information and answers from the server 174 so that the consultant may assist the users in reducing the risks of trade regulation compliance problems.

FIG. 6 also shows the use of the TCAT method and system in an identical fashion but behind the corporate firewall 184. The code for the system has been installed within on the company server 186 where it is accessed by a user 188 using a tablet computer 190 or by a user 192 using a laptop computer 194. The assessment may be evaluated by a consultant or other person 196 using a desktop computer 198.

The system shown in FIG. 6 is but one example of a system for implementing the present method. The person of skill in the art will understand that many other devices, connections and arrangements are possible.

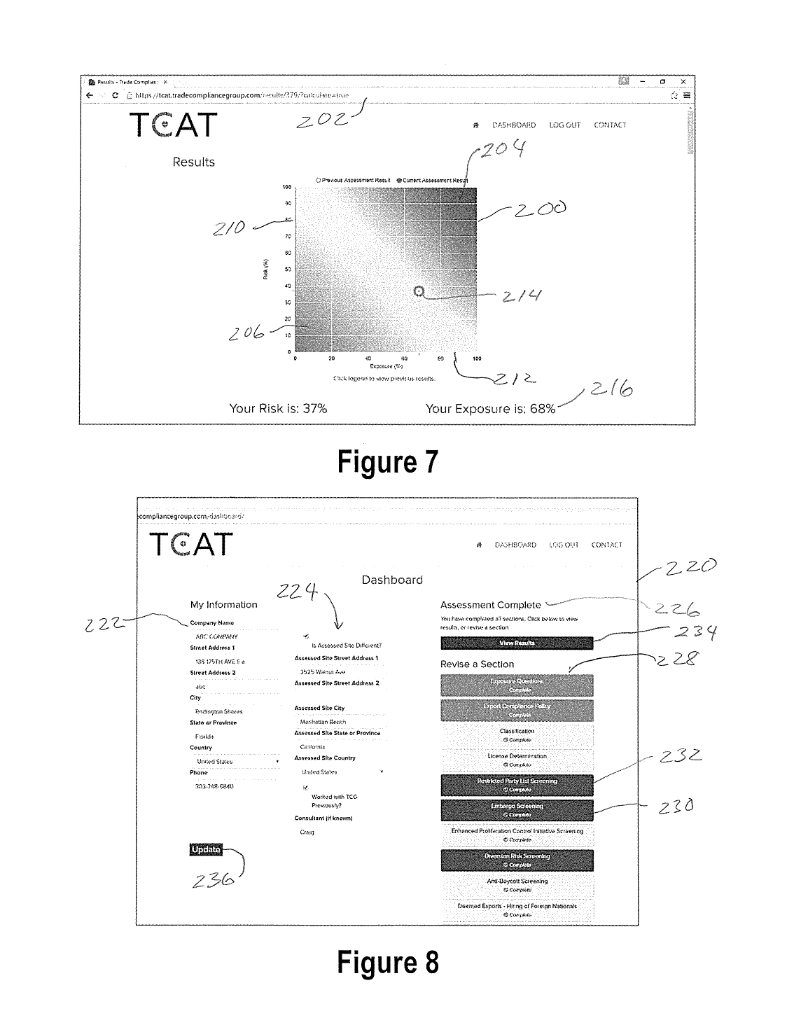

FIG. 7 shows a matrix 200 on a computer display 202 for a user using the web based system. The matrix 200 is similar to the matrix shown in FIG. 1 except that the higher risk and exposure area 204 at the upper right of the matrix 200 and the lower risk and exposure area 206 at the lower left are indicated with gradual shading rather than hard boundaries. In the example, the upper right portion 204 of the matrix 200 fades from a yellow color at the middle to red, gradually changing to a deeper red at the far upper right. The lower left area 206 fades from a yellow in the middle to green, with a deeper green being shown in the lower left. The risk values increase along the left vertical axis 210 and the exposure values increase along the bottom horizontal axis 212. A plot 214 is shown of the calculated values listed at 216. The computer display screen shot 202 includes other features of a computer browser display including an address bar, control buttons, and command menus, as is understood by those of skill in the art.

FIG. 8 shows a dashboard display 220 that provides the user with a summary of the information used in the assessment. For example, the identifying information for the entity being evaluated is shown at 222 and information on the assessment site being evaluated at 224. The status of the assessment is shown at 226, and each assessment section is indicated in a table at 228. The assessment sections 228 are color coded to indicate the level of risk or exposure that results from the assessment of each section. For example, the illustration shows that the section embargo screening 230 is colored in green as not representing a risk or exposure. The section restricted party list screening 232 is colored red to indicate to the user that the responses to this section represent a greater risk or exposure. Four colors are used in the example to indicate levels of risk and exposure. The user may select any section 228 to revise the answers. A view the results button 234 is provided by which the user may view the results of the evaluation. An update button 236 is shown for updating the information on the system.

In FIG. 9, the evaluation sections 238 are shown in a list 240. The list is sorted to show the sections that are higher exposure and risk at the top and those with lower risk and exposure sorted in order of decreasing risk and exposure. Adjacent each section is a text 242 reporting to the user the date and time of the calculation and the risk and exposure values calculated. This evaluation summary is shown on a computer display 244.

FIG. 10 shows the risk and exposure matrix 246 on which are plotted the values 248 for each of the sections 238 in the list 240. The combined risk and exposure values 250 for the sections 238 are shown as well. The plotted values are shown as small circles, although other marks may be provided instead.

Turning to FIG. 11, an evaluation has been conducted for a company having two divisions, a US division and a Chinese division. The risk and exposure values are plotted for each division of the company on a matrix 252. The matrix 252 is similar to the matrix 200 shown in FIG. 7 and has gradual shading of the greater and lower risk and exposure areas. The US division of the company is plotted on the matrix at 254 as shown by the US flag. The risk for the Chinese division is plotted at 256 as shown by the Chinese flag. The risk values for the two divisions are shown at 258. The exposure value for the two divisions is shown at 260.

Other separations may be performed instead of by country. For example, evaluations may be performed by business unit, product unit, state, region of the country, region of the world, or any other division, which the values plotted separately for the different divisions.

By breaking the results down into country or other division and by breaking the results into the sections or topics, the user may be able to identify problem areas for trade compliance and implement corrections.

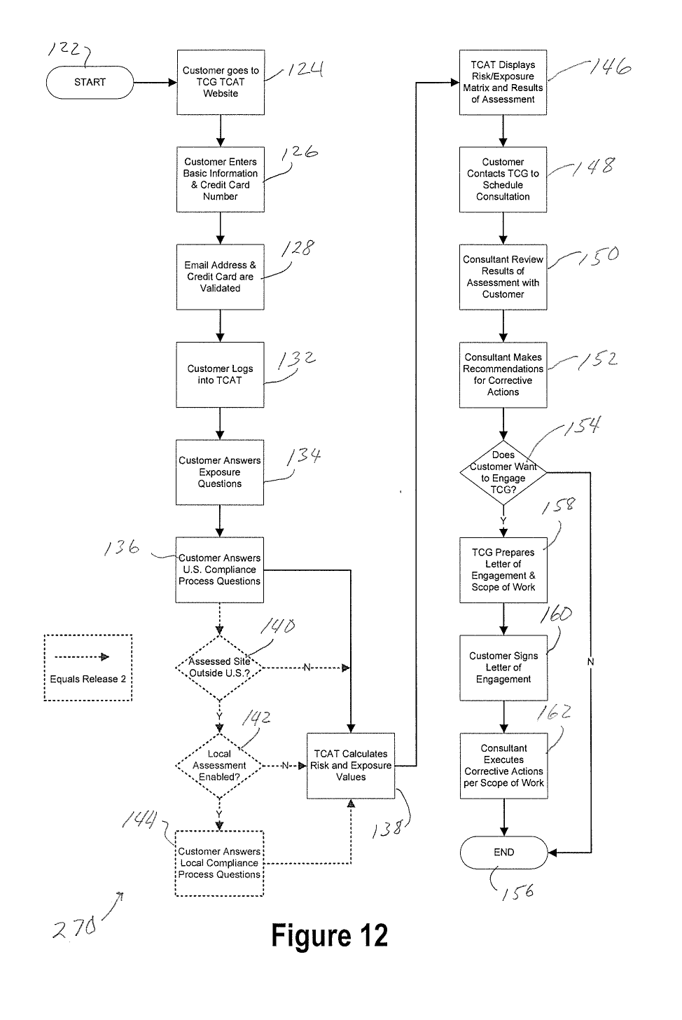

FIG. 12 shows a flow chart 270 similar to the chart 120 shown in FIG. 5. The same part numbers are used where the same description applies. The descriptions are not repeated where they are the same or similar. The primary difference between the flow chart 270 and the flow chart 120 is that chart 270 eliminates step 130.

Thus, there is shown and described a method and system for determining of compliance with trade (or other federal) regulations includes a web based system for access by a user. The user provides information and answers relating to risk factors or exposure factors of the trading entity. The exposure factors are each assigned a weighting factor. Weighted exposure factor answers are totaled and used to calculate an exposure value. Risk factor answers are assigned values and are compared to possible maximum values. Risk factor answers may be identified as imposing a greater or lesser risk as indicated by color codes. A total of the risk answer values is compared to a total of maximum values to obtain a risk value. The risk value and exposure value are plotted on a matrix. The matrix may be color coded for different levels of risk/exposure. The user may determine from the method and system if consultation relating to trade compliance is warranted.

The TCAT method and system may be used in many other jurisdictions; i.e., import compliance (ICAT). ITAR compliance (ITARCAT). Defense Security Service compliance (DSSCAT). FDA compliance (FCAT), Nuclear Regulatory Agency compliance (NRCCAT). Department of Transportation compliance (DOTCAT), Office of Foreign Assets Control compliance (OCAT), and so on. It is important to note that support for additional jurisdictions and assessment of jurisdictionally-specific compliance processes does not rely on changes to the underlying design of the TCAT method and system, but only on the question set relating to the particular jurisdiction. The structure and operation of the TCAT engine is intended to be applied to any regulated jurisdiction.

The scope of this invention extends to any online, cloud-based, or native (downloadable or separately delivered and purchased or licensed) computer program that assesses the level of risk, or risk and exposure, of any U.S. federally regulated activity; including regulated activities of the governments of foreign countries.

Although other modifications and changes may be suggested by those skilled in the art, it is the intention of the inventors to embody within the patent warranted hereon all changes and modifications as reasonably and properly come within the scope of their contribution to the art.

We claim:

1. A method for assessing trade or other federally-regulated compliance of an entity, comprising:
receiving information of the entity from a user at a web based interface;
receiving answers to questions relating to trade by the entity from the user,
calculating a risk value based on the information and the answers to the questions;
calculating an exposure value based on the information and the answers to the questions;
plotting the risk value and the exposure value on a matrix;
displaying the matrix with the plotted risk and exposure values to a user.

2. A method as claimed in claim 1, further comprising:
color coding areas of the matrix, the color coding corresponding to levels of combined risk and exposure; and
displaying the plotted risk value and exposure value in a color coded area.

3. A method as claimed in claim 2, wherein the color coding areas include first and second color coded areas, the first and second color coded areas each having an area of less than one quarter of the matrix.

4. A method as claimed in claim 1, further comprising:
plotting the risk and exposure values on the matrix for a plurality of entity locations.

5. The method as claimed in claim 4, wherein the plurality of entity locations correspond to countries in which the entity is conducting trading.

6. A method as claimed in claim 1, wherein the risk value calculation includes:
determining a value of an answer provided by the user relating to risk factors;
comparing the value of the answer to a predetermined maximum value for the answer;
repeating the determining and comparing for a plurality of answers relating to risk factors;
totaling the maximum values for the plurality of answers relating to risk factors;
totaling the values for the answers provided by the user for the plurality of answers relating to risk factors; and
calculating a percentage of total answer values compared to total maximum values as the risk value.

7. A method as claimed in claim 6, wherein the totaling of the maximum values and the totaling of the values for the answers totals only maximum values and answers values for applicable categories of answers by using zero as the maximum value and answer value of non-applicable categories when totaling.

8. A method as claimed in claim 1, wherein the exposure value calculation includes:
determining a weighting factor for a plurality of categories of exposure factors;
receiving affirmative responses from the user for a plurality of the categories of exposure factors;
applying the weighting factors to the corresponding affirmative responses from the user to obtain a weighted result;
totaling the weighting factors for the plurality of categories;
totaling the weighted results for the plurality of categories; and
calculating a percentage of the totaled weighted results compared to the totaled weighting factors as the exposure value.

9. A method as claimed in claim 8, wherein the answers to the exposure questions will, when appropriate, automatically alter the weighting factors in the risk questions, either up or down, for the plurality of categories.

10. A system for assessing trade (or other federally-regulated) compliance of an entity, comprising:
a web interface for access by a user, the web interface including requests for information and answers relating to risk factors and exposure factors of the entity;
a calculator constructed and operable to calculate a risk value and an exposure value from the information and answers; and
a matrix generator constructed and operable to generate a matrix on which the risk value and the exposure value are plotted for display to the user on the web interface.

11. A system as claimed in claim 9, further comprising:
a risk calculation generator constructed and operable to display a plurality of compliance process elements, the risk calculation generator assigning maximum values to applicable compliance process elements, the risk calculation generator assigning values to user answers in the respective compliance process elements, the risk calculation generator totaling the maximum values and the answer values, and calculating a risk value from the total maximum values and the total answer values.

12. A system as claimed in claim 10, wherein the risk calculation generator is constructed and operable color code values assigned to user answers for a plurality of the compliance process elements.

13. A system as claimed in claim 9, further comprising:
an exposure calculator constructed and operable to display a plurality of exposure factors in a plurality of exposure categories, the exposure calculator assigning weighting factors to each of the plurality of exposure factors, the exposure calculator applying the weighting factors to each respective answer and information provided by the user under the exposure categories to obtain a weighted answer value, the exposure calculator being operable to total the weighting factors and to total the weighted answer values, the exposure calculator being operable to calculate an exposure value from the total of the weighting factors and the total of the weighted answer values.
